(19) United States
(12) Patent Application Publication
(10) Pub. No.: US 2025/0267005 A1
(43) Pub. Date: Aug. 21, 2025

(54) IMAGE PROCESSING APPARATUS FOR DIGITAL SIGNATURE AND STORAGE MEDIUM

(71) Applicant: CANON KABUSHIKI KAISHA, Tokyo (JP)

(72) Inventors: MAYUMI SHIBAO, Tokyo (JP); YASUHIRO HOSODA, Kanagawa (JP); KYOHEI TAKEDA, Tokyo (JP); YUKI NARITA, Chiba (JP)

(21) Appl. No.: 19/050,369

(22) Filed: Feb. 11, 2025

(30) Foreign Application Priority Data
Feb. 21, 2024 (JP) 2024-024274

(51) Int. Cl. H04L 9/32; H04L 9/08; H04L 61/4511

(52) U.S. Cl. CPC H04L 9/3226; H04L 9/0825; H04L 61/4511

(57) ABSTRACT

An image processing apparatus comprises a user authentication unit configured to perform user authentication by verifying a digital signature using a public key stored in advance in association with an identifier of a user, wherein the digital signature is received from an information processing apparatus through HTTP communication; and a control unit configured to generate a cooperation authentication screen or a pass key authentication screen for prompting access by authentication using pass key corresponding to the public key when access to the user authentication unit from the information processing apparatus is made using an IP address in a state in which the user authentication unit is valid.

### BACKGROUND OF THE INVENTION

### Field of the Invention

The present invention relates to an image processing apparatus for a digital signature and a storage medium.

### Description of the Related Art

In recent years, since passwords used to authenticate users have had problems such as risks of unauthorized use, the number of websites providing passwordless authentication has increased. As methods of performing passwordless authentication for users, techniques such as Fast Identity Online (FIDO) 2.0 or WebAuthn defined by FIDO Alliance are known.

Japanese Patent Application Laid-open No. 2022-71684 discloses a technique for performing passwordless authentication using an external authenticator when a user logs into a service providing a service provision system, in which an authentication screen is displayed by a browser, and the user makes an authentication request on the authentication screen.

For example, an image processing apparatus or the like has a remote UI function of changing and operating a setting of the image processing apparatus via a browser from a PC. When access to the remote UI function is made, an IP address is designated and HTTP connection is performed in a LAN environment of an office in many cases.

On the other hand, regulations of FIDO 2.0 do not permit connection made using an IP address. Therefore, when access to a FIDO service is made using an IP address, a browser conforming with FIDO 2.0 returns execution of WebAuthn as an error.

Therefore, when passwordless login is provided using FIDO by the remote UI function of an image processing apparatus or the like and an IP address is designated for HTTPS connection, there is a problem that a FIDO function cannot be used.

### SUMMARY OF THE INVENTION

According to an aspect of the present invention, an image processing apparatus includes: a user authentication unit configured to perform user authentication by verifying a digital signature using a public key stored in advance in association with an identifier of a user, wherein the digital signature is received from an information processing apparatus through HTTP communication; and a control unit configured to generate a cooperation authentication screen or a pass key authentication screen for prompting access by authentication using pass key corresponding to the public key when access to the user authentication unit from the information processing apparatus is made using an IP address in a state in which the user authentication unit is valid.

Further features of the present invention will become apparent from the following description of embodiments with reference to the attached drawings.

### BRIEF DESCRIPTION OF THE DRAWINGS

FIG. 1 is a diagram illustrating a configuration example of a system according to a first embodiment of the present invention.

FIG. 2A is a diagram illustrating a hardware configuration example of an MFP 101 according to the first embodiment and FIG. 2B is a diagram illustrating a hardware configuration example of an information processing apparatus 105 according to the first embodiment.

FIG. 3 is a diagram illustrating software configuration examples of the MFP 101 and the information processing apparatus 105 according to the first embodiment.

FIG. 4 is a diagram illustrating an example of a user database stored in an HDD 204 of the MFP 101 according to the first embodiment.

FIG. 5A is a diagram illustrating an example of a login screen displayed by a web browser 314 of an information processing apparatus according to the first embodiment.

FIG. 5B is a diagram illustrating an example of a device situation screen 504 after login displayed by the web browser 314 of the information processing apparatus according to the first embodiment.

FIG. 6A is a diagram illustrating an example of a login method setting screen 601 of a remote UI of the information processing apparatus according to the first embodiment.

FIG. 6B is a diagram illustrating an example of a user account management screen 602 of the information processing apparatus according to the first embodiment.

FIG. 6C is a diagram illustrating an example of a user account edit screen 603 of the information processing apparatus according to the first embodiment.

FIG. 7A is a flowchart illustrating a processing example of pass key authentication of a URL according to the first embodiment.

FIG. 7B is a flowchart illustrating a processing example of a DNS auto registration of the URL according to the first embodiment.

FIG. 7C is a flowchart illustrating a processing example of IP address change of the URL according to the first embodiment.

FIG. 8A is a diagram illustrating a sequence example of pass key authentication according to the first embodiment.

FIG. 8B is a diagram illustrating a sequence example continued from FIG. 8A.

FIG. 9 is a flowchart illustrating a verification processing example of the URL in step S803 of FIG. 8B.

FIG. 10 is a flowchart illustrating a redirection processing example of the URL in step S803 of FIG. 8B.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

In a first embodiment, an example of a multi function printer (MFP) that has functions of copy, print, scan, and the like as an image processing apparatus will be described. Here, the image processing apparatus may be, for example, an image generation apparatus, an image edit apparatus, or the like and is not limited to an MFP.

In the present embodiment, a digital signature verification technique is adopted as an authentication structure with which a user uses a function or a service provided by the image processing apparatus. Specifically, in the first embodiment, pass key authentication is performed by a PC used by the user, and the user is authenticated by verifying digital signature data output as a result on an image processing apparatus side.

In the first embodiment, a digital signature verification service function corresponding to a FIDO service in a FIDO technique is mounted on the image processing apparatus. Here, a method for digital signature verification in the present embodiment is not limited to FIDO and includes using another method.

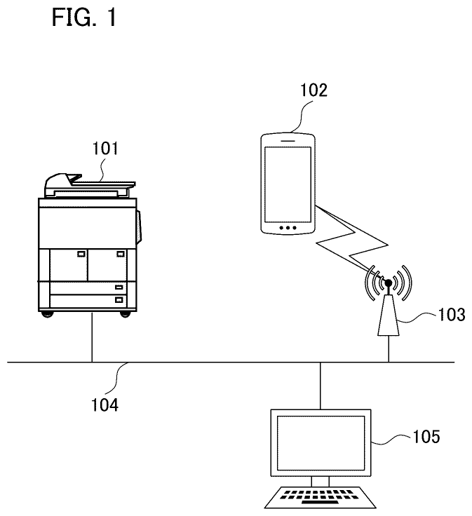

FIG. 1 is a diagram illustrating a configuration example of an authentication system according to a first embodiment of the present invention. Reference numeral 101 denotes an MFP according to the present embodiment. Reference numeral 102 denotes a mobile terminal such as a smartphone, for example, a terminal on which iOS of Apple Inc. is mounted or a terminal on which Android (registered trademark) of Google Inc. is mounted.

The mobile terminal 102 can communicate with the MFP 101 via an access point 103 of a wireless local area network (LAN) or a wired LAN 104 or the like.

An information processing apparatus 105 can also communicate with the MFP 101 via the wired LAN 104. When the MFP 101 has an access point function of a wireless LAN, the mobile terminal 102 may be configured to be connected to the wireless LAN access point function of the MFP 101 and perform direct communication.

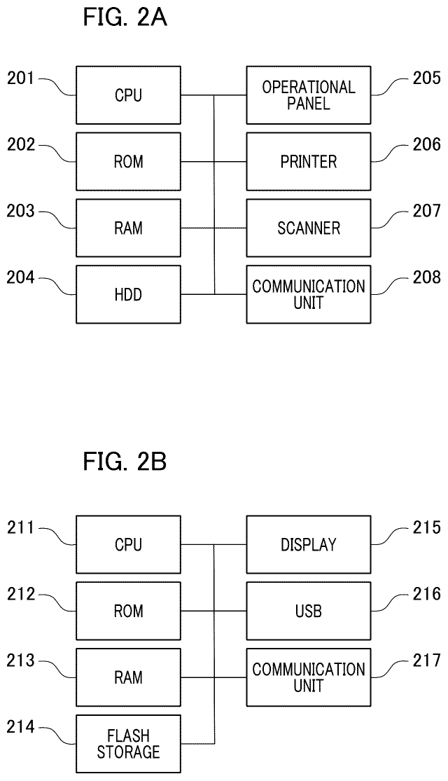

FIG. 2A is a diagram illustrating a hardware configuration example of the MFP 101 according to the first embodiment. Reference numeral 201 denotes a CPU serving as a computer that controls an operation of the entire MFP 101. Reference numeral 203 denotes a random access memory (RAM) that serves as a work area and is used as a temporary storage area on which various control programs stored in the ROM 202 or the HDD 204 are loaded.

Reference numeral 202 denotes a read only memory (ROM) that stores a boot program or the like of the MFP 101. Reference numeral 204 denotes an HDD that includes a nonvolatile hard disk or a flash storage and stores a computer program for controlling the MFP. A computer program such as an operating system (OS) or an application program is also stored in the HDD 204.

The CPU 201 executes the boot program stored in the ROM 202 when the MFP 101 is started. The boot program is a program for reading a program of an OS stored in the HDD 204 and loading the program onto the RAM 203.

When the CPU 201 executes the boot program, the CPU 201 continuously executes the program of the OS loaded onto the RAM 203 and controls the MFP 101.

The CPU 201 also stores data used for an operation in accordance with the control computer program on the Ram 203 and performs reading and writing.

In the MFP 101, one CPU 201 performs each process illustrated in a flowchart to be described below. For example, a plurality of CPUs or microprocessors (MPUs) may perform each process illustrated in the flowchart to be described below in cooperation.

Some of the processes to be described below may be performed using a hardware circuit such as an application specific integrated circuit (ASIC) or a field-programmable gate array (FPGA).

Reference numeral 205 denotes an operational panel including a display (touch panel) on which a touch operation can be performed. Reference numeral 206 denotes a printer that prints print data received from the outside via a communication unit 208 or digital data acquired from a scanner 207.

Reference numeral 207 denotes a scanner that reads a sheet document and digitizes the read sheet document. Reference numeral 208 denotes a communication unit that includes a network interface for connection to the Internet or a local area network (LAN) of an office.

FIG. 2B is a diagram illustrating a hardware configuration example of an information processing apparatus 105 according to the first embodiment. Reference numeral 211 denotes a CPU that serves as a computer controlling an operation of the entire information processing apparatus 105. Reference numeral 213 denotes a RAM that is used as a temporary storage area on which various control programs stored in the ROM 212 and a flash storage 214 are loaded.

Reference numeral 212 denotes a ROM that stores a boot program or the like of the information processing apparatus 105. The flash storage 214 is a nonvolatile memory storage and stores a control computer program of a mobile terminal. An OS or an application program is also stored in the flash storage 214.

Reference numeral 215 denotes a display formed of, for example, a liquid crystal or an organic EL that displays a UI displaying an application program. Reference numeral 216 denotes a USB interface for USB connection. Reference numeral 217 denotes a communication unit that performs wired or wireless LAN communication or the like.

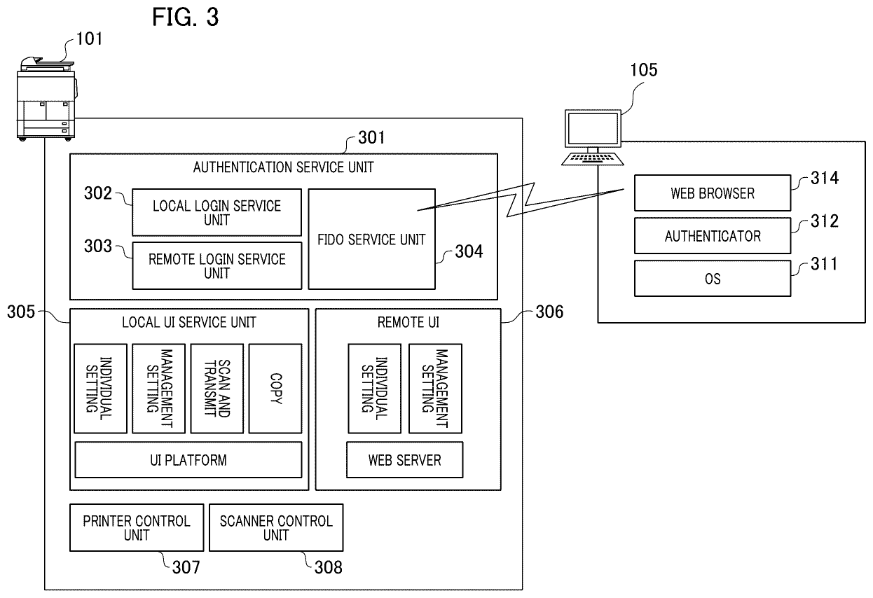

FIG. 3 is a diagram illustrating software configuration examples of the MFP 101 and the information processing apparatus 105 according to the first embodiment. In the first embodiment, some of functional blocks illustrated in FIG. 3 are realized by causing a CPU or the like serving as a computer included in the MFP 101 and the information processing apparatus 105 to execute a computer program stored in a memory serving as a storage medium.

However, some or all of the functional blocks may be realized by hardware. As hardware, as described above, a dedicated circuit (ASIC) or a processor (reconfigurable processor or a DSP) can be used. The respective functional blocks illustrated in FIG. 3 need not be contained in the same casing and may be configured as separate apparatuses connected to each other via signal lines.

Reference numeral 301 denotes an authentication service unit that authenticates a user using the MFP 101 and includes a local login service unit 302, a remote login service unit 303, and a fast identity online (FIDO) service unit 304.

The local login service unit 302 displays a login screen on the operational panel 205 and authenticates a user using the operational panel for performing login via the operational panel. The remote login service unit 303 authenticates a user accessing a web service (remote UI) via the communication unit 217 for performing login in the remote UI.

The FIDO service unit 304 has a web service function that can communicate by a hypertext transfer protocol (HTTP)/hypertext transfer protocol secure (HTTPS). The FIDO service unit 304 has an authentication function of WebAuthn defined by FIDO Alliance or W3C.

The FIDO service unit 304 functions as a user authentication unit that performs user authentication by receiving a digital signature by HTTPS or HTTP communication from the information processing apparatus 105 and verifying the digital signature using a public key stored in association with an identifier of the user in advance.

The local UI service unit 305 of the MFP 101 provides a user interface that provides a function to a user logging in the operational panel. The local UI service unit 305 includes a menu used for a user to select a function, an application, and a UI platform controlling screen transition.

For example, the local UI service unit 305 includes a “copy” application that controls the printer 206 or the scanner 207 and provides a copy function to a user and a “scan and transmit” application that controls the scanner 207 and the communication unit 208 and provides a function of transmitting a scan document.

The remote UI 306 provides a user interface that is displayed with a web browser of the information processing apparatus 105 to a user logging in a web service. The remote UI 306 includes “individual setting,” “management setting,” “application,” and “web server” for changing a setting of a function by a user.

A printer control unit 307 is a software module that controls the printer 206 and a scanner control unit 308 is a software module that controls the scanner 207.

The software modules provide application programming interfaces (APIs) that start the printer 206 and the scanner 207 to applications. A software configuration of the MFP 101 includes driver software that controls an operating system or various types of hardware.

An OS 311 of the information processing apparatus 105 is an operating system. An authenticator 312 is software that has a FIDO authenticator function defined by FIDO Alliance. A function of the authenticator 312 may be embedded as one function of the operating system (OS 311) in the operating system.

A web browser 314 is software that operates as a client function performing HTTP communication. For example, Safari of Apple Inc. or Chrome of Google Inc., Edge of Microsoft Inc., or the like is configured.

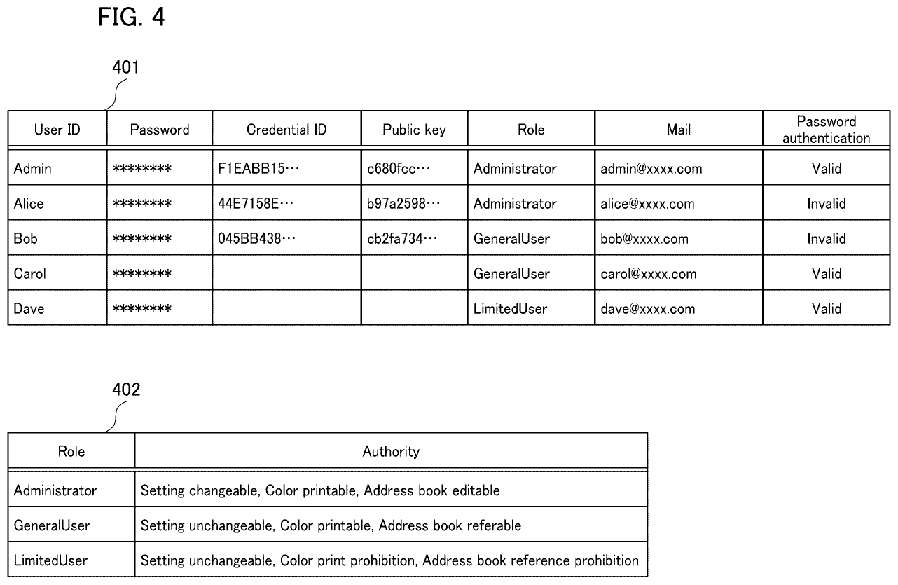

FIG. 4 is a diagram illustrating an example of a user database stored in the HDD 204 of the MFP 101 according to the first embodiment. In the HDD 204, the MFP 101 stores user account information in a user database 401 illustrated in FIG. 4 manages the user account information. Encryption and tamper-prevention measures of a communication path or a storage may be performed, and then a database of another node on a network may be used.

As illustrated in FIG. 4, in the user database 401 according to the first embodiment, a user ID, a password, pass key information (a credential ID and a public key) used for FIDO authentication, a role, a mail address, validity/invalidity of password authentication are recorded.

The “user ID” is an identifier for identifying a user. The “password” is a password used for authentication. The “role” is information indicating a use authority of user for the MFP 101. Examples of each role and the use authority are shown in a role information table 402.

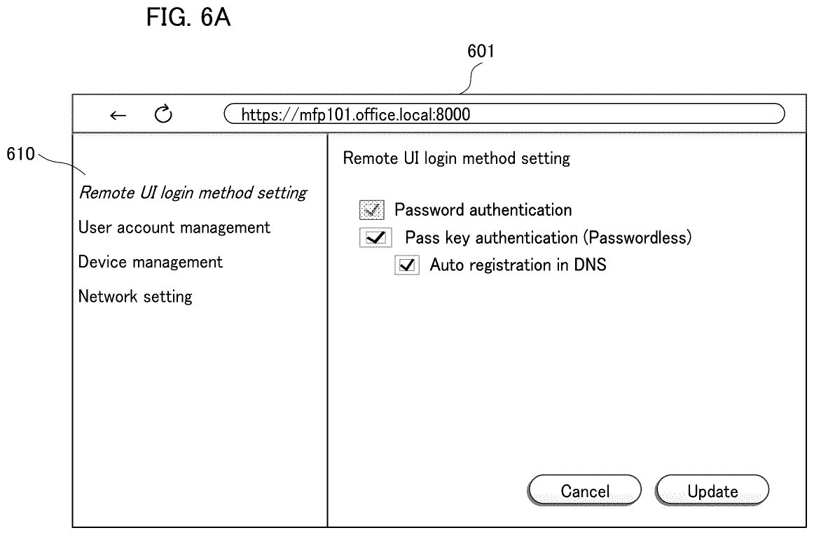

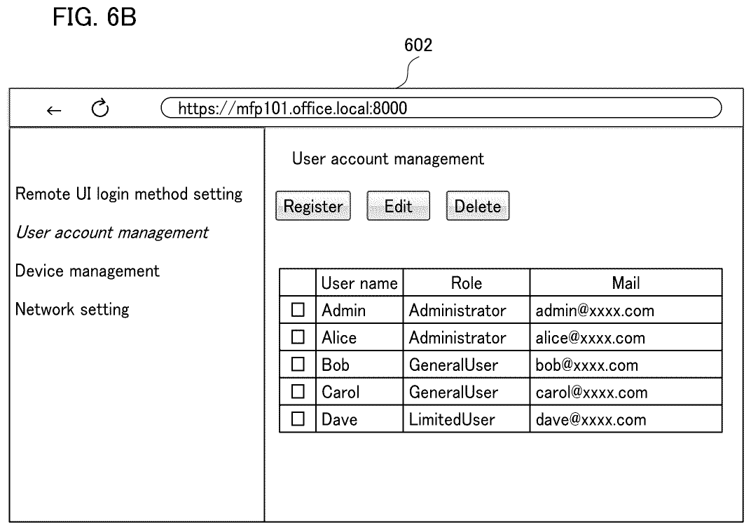

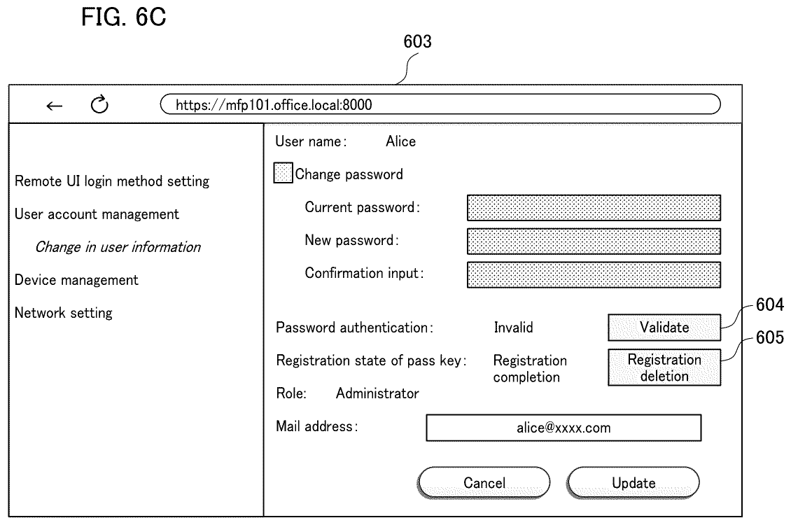

In addition to definition of the roles defined in factory shipment of the MFP 101, a user may be allowed to set a detailed use authority and and generate a new role. Registration, editing, and deletion of user account information are performed via UIs of a user account management screen 602 of FIG. 6B and a user account edit screen 603 of FIG. 6C, as will be described below.

The user database 401 is referred to from the user authentication service unit 301 to authenticate a user. The pass key information such as the credential ID and the public key is stored via the FIDO service unit 304.

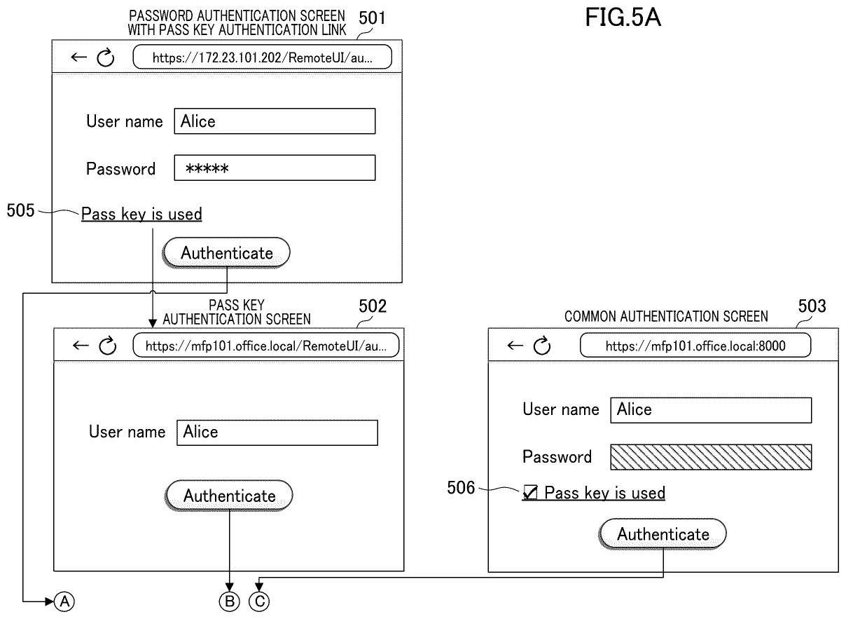

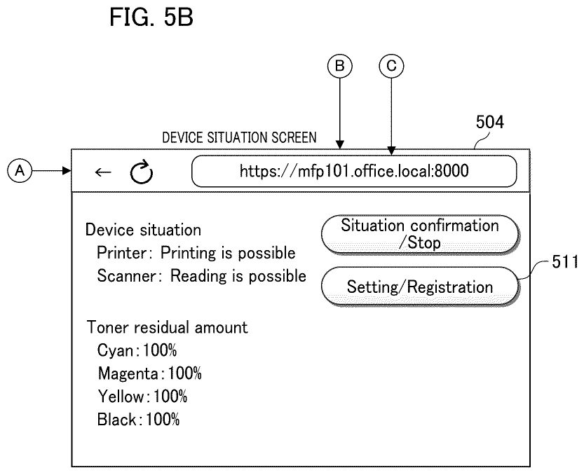

Next, the user authentication function of the MFP 101 will be described with reference to FIGS. 5A, 5B, and 6A to 6C. FIG. 5A is a diagram illustrating an example of a login screen displayed by a web browser 314 of an information processing apparatus according to the first embodiment. FIG. 5B is a diagram illustrating an example of a device situation screen 504 after login displayed by the web browser 314 of the information processing apparatus according to the first embodiment.

FIG. 6A is a diagram illustrating an example of a login method setting screen 601 of a remote UI of the information processing apparatus according to the first embodiment. FIG. 6B is a diagram illustrating an example of the user account management screen 602 of the information processing apparatus according to the first embodiment.

FIG. 6C is a diagram illustrating an example of the user account edit screen 603 of the information processing apparatus according to the first embodiment. The screens illustrated in FIGS. 6A to 6C are displayed when a setting registration menu 511 illustrated in FIG. 5B is pressed, and screen display is switched when a switch menu of 610 is selected.

On the login method setting screen 601 of the remote UI, a method for login in the remote login service unit 303 can be selected. In the present embodiment, it is assumed that “password authentication” is normally valid and “pass key authentication (passwordless)” can be selected for validity.

In the password authentication, a method for login by inputting a user ID and a password is provided. In the pass key authentication (passwordless authentication), a user is authenticated using PKI or the like defined in FIDO called a pass key in cooperation with the remote login service unit 303, the FIDO service unit 304, and the authenticator 312. PKI is an abbreviation for public key infrastructure.

When the pass key authentication (passwordless) is validated on the login method setting screen 601 of FIG. 6A, that is, when the user authentication unit is valid, the pass key authentication screen 502 of FIG. 5A is displayed on the web browser 314 as a login screen to authenticate the user.

When both password authentication and mobile authentication (pass key authentication) are validated on the login method setting screen 601 of FIG. 6A, a password authentication screen 501 with a pass key authentication link is displayed on the login screen of FIG. 5A and a common authentication screen 503 are displayed on the web browser 314

That is, when connection to HTTPS is made using an IP address, the password authentication screen 501 with the pass key authentication link is displayed. When connection to HTTPS is connected using a host name, the common authentication screen 503 is displayed. The password authentication screen 501 with the pass key authentication link functions as a cooperation authentication screen for prompting access by pass key authentication using a pass key.

In the password authentication screen 501 with the pass key authentication link, a field for inputting a user name and a password and a pass key authentication link 505 displayed as “Pass key is used” are disposed.

In the pass key authentication link 505, a link of a URL for accessing the pass key authentication using a host name is set. When a URL link (the pass key authentication link 505) is pressed, the pass key authentication screen 502 is displayed. That is, on the password authentication screen 501 with the pass key authentication link that is a cooperation authentication screen, a URL link (the pass key authentication link 505) to the pass key authentication screen 502 is displayed.

On the other hand, on the common authentication screen 503, a login screen can be switched with a checkbox 506 such as “Pass key is used” and login can be performed by password authentication by inputting a user name and a password when there is no check.

When the checkbox 506 such as “Pass key is used” is checked, an input of a password input field becomes disabled and login can be performed with the pass key authentication by inputting the user name. The details of an authentication method with a pass key will be described below.

When authentication of the user is successful by password authentication or pass key authentication (passwordless), the remote login service unit 303 causes the user to log in a screen displayed in the web browser 314. When the login is successful, the remote UI 306 detecting the login of the user displays a device situation screen 504 in the web browser 314.

### DNS Auto Registration

In FIDO 2.0, connection using an IP address cannot be made. Therefore, in the present embodiment, access is made with a host name when access to the FIDO service unit 304 is made. To make access to the FIDO service unit 304 with the host name, the host name and the IP address of the MFP 101 are registered in advance in a DNS server by the following method.

When the pass key authentication (passwordless) is validated on the login method setting screen 601 of FIG. 6A, “Auto registration in DNS” can be validated. That is, the login method setting screen 601 functions as a DNS registration setting unit enabling a setting regarding whether to perform auto registration in a DNS in a state in which the user authentication unit is valid.

When “Auto registration in DNS” is validated, the remote login service unit 303 can register the host name and the IP address of the MFP 101 in a DNS server.

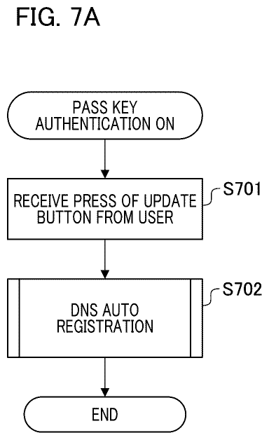

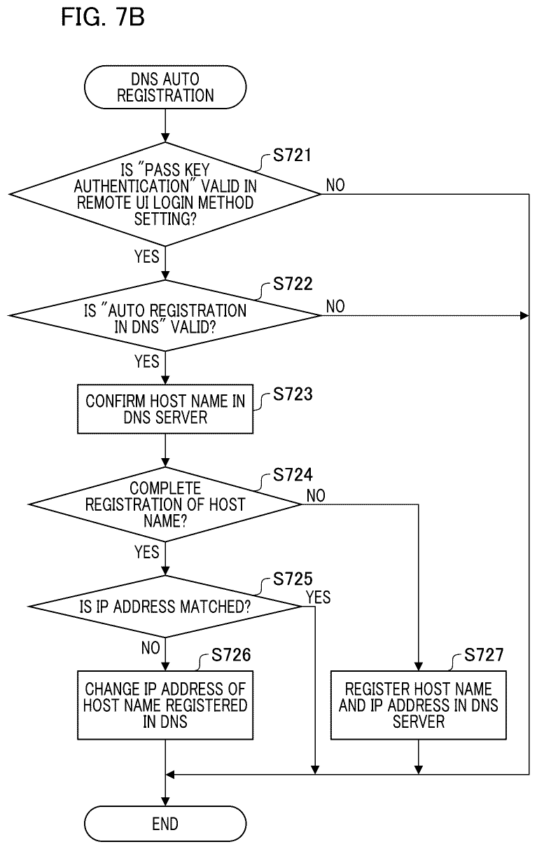

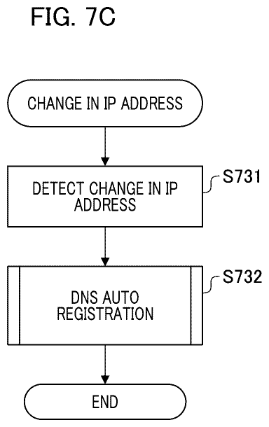

The method will be described with reference to the flowcharts of FIGS. 7A and 7B. FIG. 7A is a flowchart illustrating a processing example of pass key authentication of a URL according to the first embodiment. FIG. 7B is a flowchart illustrating a processing example of a DNS auto registration of the URL according to the first embodiment. FIG. 7C is a flowchart illustrating a processing example of IP address change of the URL according to the first embodiment.

Each step illustrated in the flowcharts of FIGS. 7A to 7C is realized by causing the CPU 201 serving as a computer to read a computer program stored in the ROM 202 or the HDD 204 serving as a storage medium to the RAM 203.

When a press of an update button of the login method setting screen 601 of FIG. 6A is received from a user in step S701 of FIG. 7A, a DNS auto registration process is performed in step S702. Next, the DNS auto registration process will be described with reference to FIG. 7B.

In step S721, it is determined whether the pass key authentication (passwordless) of the login method setting screen 601 of FIG. 6A is validated. In the case of Yes, the process proceeds to step S722. In the case of No, the flow of FIG. 7B ends.

When the pass key authentication (passwordless) is valid in step S721, it is determined whether “Auto registration in DNS” is valid in step S722. In the case of Yes in step S722, the process proceeds to step S723. In the case of No, the flow of FIG. 7B ends.

In step S723, it is confirmed whether a host name of the MFP 101 and an IP address associated with the host name are registered in a DNS server. Subsequently, when Yes is determined in step S724, the process proceeds to S725. When No is determined, the process proceeds to step S727.

In step S725, it is determined whether the IP address associated with the host name acquired from the DNS server matches an IP address of the MFP 101. In the case of No, the process proceeds to step S726. In the case of Yes, the flow of FIG. 7B ends.

In step S726, the IP address associated with the host name registered in the DNS server is changed to the IP address of the MFP 101. When the host name is not registered in the DNS server in step S724, the host name and the IP address of the MFP 101 are registered in the DNS server in step S727.

In this way, in the present embodiment, when the DNS registration setting unit is set to perform the auto registration in the DNS, the host name and the IP address are registered in the DNS in steps S726 and S727. Thereafter, the flow of FIG. 7B ends.

In the present embodiment, the setting of “Auto registration in DNS” may be automatically validated in conjunction with the validation of the pass key authentication (passwordless) on the login method setting screen 601 of FIG. 6A. Accordingly, it is possible to prevent the user from erroneously setting “Auto registration in DNS” to negative.

As described above, the flow of the auto registration of the host name and the IP address in the DNS server has been described with reference to FIG. 7B. On the other hand, the IP address assigned to the MFP 101 is changed in some cases. When the IP address of the MFP 101 is changed in the state in which “Auto registration in DNS” is valid in FIG. 6A, the IP address assigned to the MFP 101 is registered again in the DNS server. This processing example will be described with reference to FIG. 7C.

In step S731 of FIG. 7C, the change in the IP address of the MFP 101 is detected and the NDS auto registration is performed in step S732. The DNS auto registration is performed in accordance with a method similar to that of FIG. 7B. In accordance with above-described processing method, the host name and the IP address can be simply registered in the NDS server.

### FIDO Service Function

The FIDO service unit 304 has a web server function capable of performing communication by HTTP and an authentication function of WebAuthn defined by FIDO Alliance or W3C. The FIDO service unit 304 is accessed from the web browser 314 of the information processing apparatus 105 through HTTPS communication and provides access and functions of URL1 to URL3 as a web server as follows, for example.

URL1(https://mfp101.office.local/RemoteUI/authentication/) serving as a URL for responding HTML for pass key authentication.

The HTML for returning pass key authentication includes JavaScript for access to REST API of URL2 and URL3 or JavaScript of the following WebAuthn defined by FIDO 2.0. Here, REST is an abbreviation for representational state transfer.

Output JSON data=awaitnavigator.credentials.get (input JSON data):

URL2(https://mfp101.office.local/RemoteUI/authentication/challenge)

URL2 is a URL of REST API responding with input JSON data for input to the above navigator.credentials.get( ) The input JSOn data includes a challenge issued by the FIDO service unit 304. The challenge is assumed to be a random number.

URL3(https://mfp101.office.local/RemoteUI/authentication/verification)

URL3 is a URL of REST API receiving information for pass key authentication and receives output JSON data output by an API of navigator.credentials.get( ) The output JSON data includes a credential ID, a challenge, and a digital signature of a pass key used for a digital signature.

### Pass Key Authentication Sequence

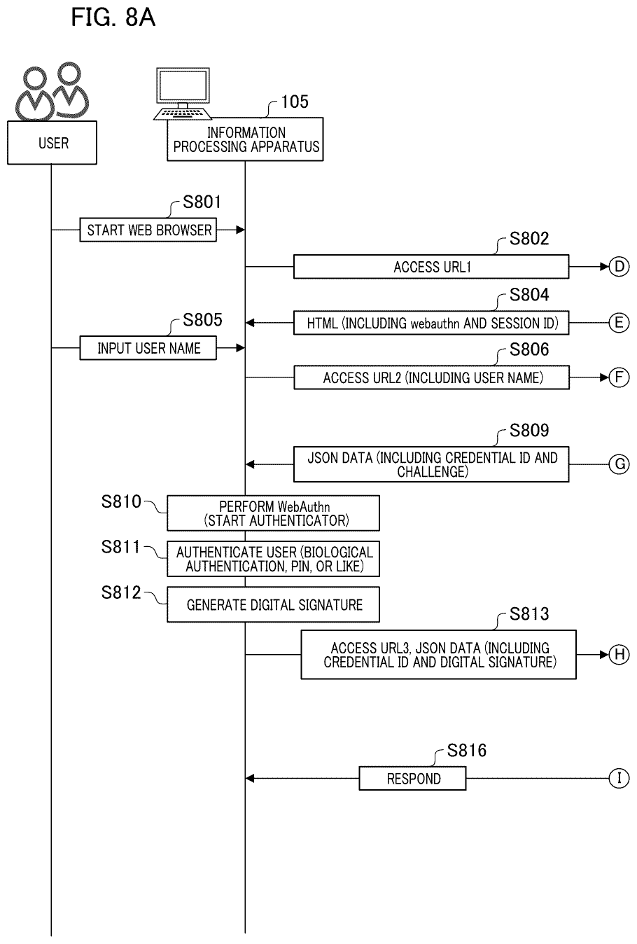

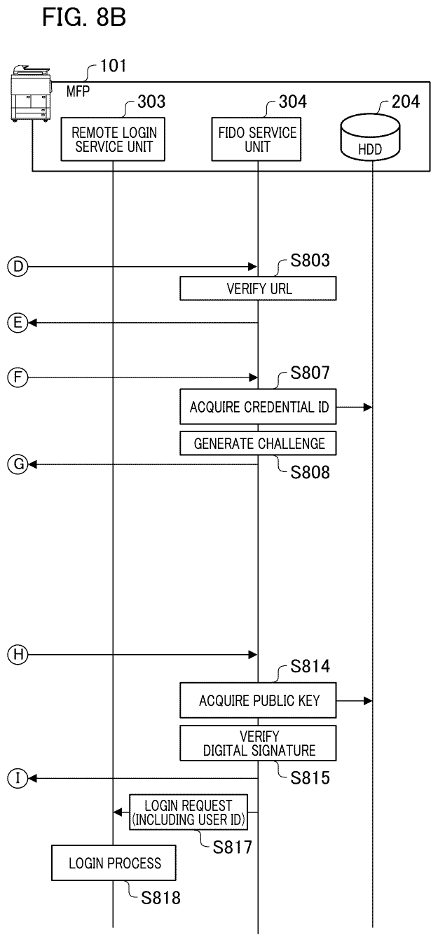

Next, a processing flow of login in which a pass key is used will be described with reference to FIGS. 8A and 8B. FIG. 8A is a diagram illustrating a sequence example of pass key authentication according to the first embodiment. FIG. 8B is a diagram illustrating a sequence example continued from FIG. 8A.

Each step shown in the sequences of FIGS. 8A and 8B is realized by causing a CPU serving as the information processing apparatus 105 and a computer of the MFP 101 to execute a computer program stored in a memory serving as a storage medium in response to a user operation.

In step S801, the user starts the web browser 314 of the information processing apparatus 105. Subsequently, in step S802, the web browser 314 accesses an address of URL1.

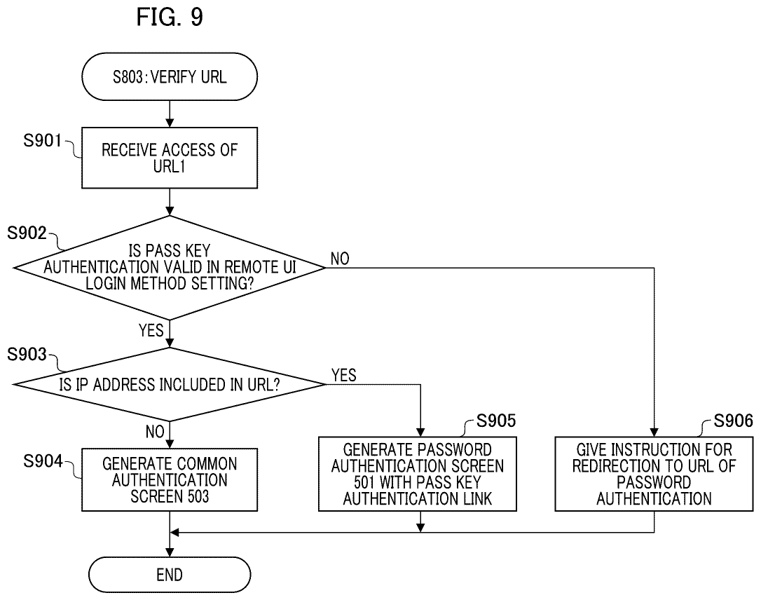

The FIDO service unit 304 verifies an accessed URL in step S803 of FIG. 8B. Here, a URL verification process of step S803 will be described with reference to the flowchart of FIG. 9.

FIG. 9 is a flowchart illustrating a verification processing example of the URL in step S803 of FIG. 8B. Each step shown in the flowchart of FIG. 9 is realized by causing the CPU 201 serving as a computer to read a computer program stored in the ROM 202 or the HDD 204 to the RAM 203 and execute the computer program.

In step S901, the FIDO service unit 304 of the MFP 101 detects and receives the access of URL1. In step S902, on the login method setting screen 601 of the remote UI, it is determined whether the pass key authentication (passwordless) is valid.

When Yes is determined in step S902, it is verified in step S903 whether the IP address is included in the URL. Conversely, when No is determined in step S902, the process proceeds to step S906. When it is determined in step S903 that the IP address is not included in the URL, HTML of the common authentication screen 503 is generated in step S904. After the process of step S904, the flow of FIG. 9 ends.

Conversely, when the IP address is included in step S903, HTML of the password authentication screen 501 with the pass key authentication link is generated in step S905. That is, when access from the information processing apparatus to the digital signature verification service unit is made using the IP address in a state in which the user authentication unit is valid, the password authentication screen 501 with the pass key authentication link for prompting access by the pass key authentication using a pass key is generated.

Thereafter, the flow of FIG. 9 ends. Here, step S905 or the like functions as a control step (control unit) of generating the cooperation authentication screen when the access is made using the IP address in the state in which the user authentication unit is valid.

When the user accesses the pass key authentication link 505 of the password authentication screen 501 with the pass key authentication link (the cooperation authentication screen), the pass key authentication screen 502 is displayed so that the pass key authentication can be used.

When No is determined in step S902, an instruction for redirection to a URL of password authentication is given in step S906, the web browser 314 displays a screen (not illustrated) for password authentication, and the flow of FIG. 9 ends.

When the process of step S803 illustrated in FIG. 9 ends, HTML of the pass key authentication screen 502 generated in step S904 is transmitted to the information processing apparatus 105 in step S804 of FIG. 8A. HTML of the pass key authentication screen 502 includes JavaScript for access to REST API of URL2 or URL3 or JavaScript of the following Web Authn defined by FIDO 2.0.

Output JSON data=awaitnavigator.credentials.get(input JSON data).

In the present embodiment, a header of a communication packet in step S804 includes a session ID to be stored in Cookie of the web browser 314. The session ID is used to confirm that the access of URL2 and URL3 is made in the same session.

Accordingly, when direct access to URL2 or URL3 is made in a state in which there is no session ID in Cookie, the FIDO service unit 304 can return with an error without processing a request.

In step S804, like the pass key authentication screen 502, the user is allowed to input the user ID in step S805, including a text field for inputting a user ID (user name). In step S806, the web browser 314 of the information processing apparatus 105 accesses an address of URL2. The user ID is included when the access to URL2 in step S806 is made.

The FIDO service unit 304 receiving the access to URL2 acquires the credential ID associated with the user ID from the user database in step S807. In step S808, a challenge is generated. The challenge is a random number.

The FIDO service unit 304 subsequently transmits the input JSON data (including the credential ID and the challenge) to the information processing apparatus 105 in step S809. Accordingly, even when a plurality of pass keys are managed the authenticator 312 side of the information processing apparatus 105, the pass keys used from the credential ID can be narrowed down to one pass key.

The input JSON data includes, for example, information regarding a server (for example, a host name or a domain name such as mfp101.office.local).

Subsequently, in step S810, the web browser 314 of the information processing apparatus 105 performs the following JavaScript of WebAuthn using the received input JSON data and starts the authenticator 312.

Output JSON data=awaitnavigator.credentials.create (input JSON data):

When the authenticator 312 manages the plurality of pass keys in association with the information regarding the server, a screen for selecting one pass key from the plurality of pass keys may be displayed.

Subsequently, in step S811, the authenticator 312 of the information processing apparatus 105 authenticates the user of the information processing apparatus 105 by biological authentication, PIN, or the like of WindowsHello. The user may be authenticated by inserting a USB key into the USB 216 of the information processing apparatus 105.

Subsequently, in step S812, the authenticator 312 of the information processing apparatus 105 acquires a pass key (a secret key of PKI) stored in association with the information regarding the server (for example, mfp101.office.local). Then, a digital signature is generated using the secret key for data including the challenge received in step S809.

The authenticator 312 returns the output JSON data to the web browser. The output JSON data includes the digital signature or a credential ID of the pass key used for the digital signature.

Subsequently, in step S813, the web browser 314 accesses URL3 and transmits the output JSON data including the credential ID, and the digital signature to the FIDO service unit 304. Here, in step S813, the MFP 101 serving as the image processing apparatus functions as a digital signature reception step of receiving the digital signature from the information processing apparatus 105 through the HTTP communication.

Subsequently, in step S814, the FIDO service unit 304 acquires the user ID and the public key of an account associated with the received credential ID with reference to the user database of the HDD 204.

Subsequently, in step S815, the digital signature received in step S813 is verified using the challenge issued by the own in step S808 and the public key acquired from the user database in step S814. When the digital signature is successful, the authentication is determined to be successful. When the digital signature fails, the authentication is determined to fail.

Subsequently, in step S816, whether the authentication is successful responds. When the authentication is successful, the FIDO service unit 304 requests the remote login service unit 303 to log in the operational panel in step S817. The login request includes the user ID.

Subsequently, in step S818, the remote login service unit 303 performs a login process of allowing the user with the user ID designated in step S817 to log in the screen displayed in the web browser.

Specifically, user information such as a user ID, a role, and a mail address of an account for allowing login is acquired with reference to the user database of the HDD 204. Further, the remote UI 306 is notified of a login occurrence event. The login event includes information regarding the user allowed to log in.

Here, steps S815 to S818 function as a user authentication step (user authentication unit) of performing the user authentication by verifying the digital signature using the public key stored in advance in association with an identifier of the user.

When the verification is not successful in step S814, the information processing apparatus 105 is notified of the failure in step S816. The case in which the verification is not successful is, for example, a case of “Designated User ID is not registered in user DB,” “Public key corresponding to pass key is not registered in association with user ID,” “Verification of digital signature fails” in step S815, or the like.

Since the above-described pass key authentication (passwordless) has a security level higher than the password authentication, the user registering the pass key information may prefer login by the pass key authentication (passwordless). This method will be described.

That is, when the pass key information is registered in the web browser 314, a screen (not illustrated) for selecting whether to invalidate the password authentication is displayed. When the user selects invalidation on the screen, the invalidation of the password authentication is stored in the user database of the HDD 204 in association with the user ID.

Thereafter, the user invalidating the password authentication performs control such that login of a user ID and a password is not performed and login can be performed in the remote UI by only the pass key authentication (passwordless).

The validation/invalidation of password authentication of each user and confirmation, registration, and deletion of a registration state of pass key information can be performed on the user account edit screen 603 of FIG. 6C. An administrator displays the user account edit screen 603 of a selected user by clicking and selecting a checkbox for the user desired to be edited and pressing an edit button on the user account management screen 602.

A general user can display the user account edit screen 603 of an own account by selecting “user account management” in the switch menu of 610 displayed by pressing the setting registration menu 511.

On the user account edit screen 603, the invalidated password authentication can be validated again by pressing the validation button 604. In the case of “State in which pass key information registration is completed” and “Password authentication is valid,” an invalidation button is displayed instead of the validation button 604 so that the password authentication can be invalidated.

When “Pass key information is not registered,” “Password authentication” cannot be disabled by the user in order to maintain the user login function.

When “Registration state of pass key information” is “Registration completion state” on the user account edit screen 603 of FIG. 6C, the pass key information can be deleted by pressing a “registration deletion” button 605. When the pass key information is deleted, the user cannot log in with the pass key. Therefore, the invalidated “Password authentication” may be automatically configured to “Validate” such as 604.

When the pass key information is not registered, “Non-registration” is displayed in “Registration state of pass key information.” When the pass key information is not registered, the registration deletion button 605 may be configured to be grayed out or not to be displayed.

When the user logs in the remote UI in the above configuration, passwordless login can be provided without being conscious of making access with a host name. Here, the user account edit screen 603 of FIG. 6C functions as a user authentication switching unit that switches a setting of validity/invalidity of the user authentication unit.

When the passwordless login is validated, an environment setting necessary for password login in a LAN environment is arranged by automatically registering a host name and an IP address in a DNS server. Accordingly, the passwordless login of the remote UI can be easily used.

### Second Embodiment

In the first embodiment, the method of displaying a link for accessing a host name when URL access is made with an IP address, allowing a user to press the link to perform switch to a host name access and perform the passwordless login has been described.

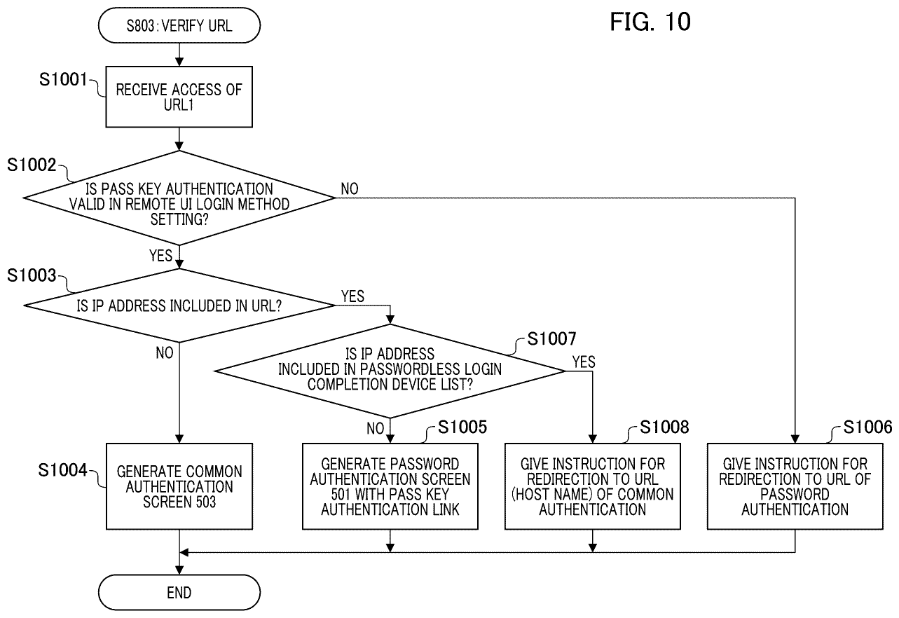

In a second embodiment, when a passwordless login completion device list is registered in the information processing apparatus 105 and access of URL1 after the subsequent time, redirection to URL access of a host name is made. This method will be described with reference to FIG. 10.

FIG. 10 is a flowchart illustrating a redirection processing example of the URL in step S803 of FIG. 8B. Each step illustrated in FIG. 10 is realized by causing the CPU 201 serving as a computer to execute a computer program stored in the ROM 202 or the HDD 204. Steps S1001 to S1006 of FIG. 10 are steps corresponding to steps S901 to S906 of FIG. 9, and only differences will be described.

When the digital signature is verified in step S815 of FIG. 8B and the authentication is successful, an IP address of the information processing apparatus 105 is added to the passwordless login completion device list stored in an HDD.

When it is determined that the IP address is included in an URL in step S1003 of FIG. 10 in the verification of the URL of step S803, the process proceeds to step S1007. In step S1007, it is determined whether an IP address of the information processing apparatus 105 of an access source is included in the passwordless login completion device list.

When No is determined in step S1007, the process proceeds to step S1005. In step S1005, HTML of the password authentication screen 501 with the pass key authentication link is generated and the flow of FIG. 10 ends.

Conversely, when Yes is determined in step S1007, an instruction for redirection to a URL (host name) of the pass key authentication is given in step S1008 and the web browser 314 displays the common authentication screen 503 serving as a pass key authentication screen. In step S1008, the pass key authentication screen 502 may be displayed.

Here, step S1008 functions as a control step (control unit) of generating the pass key authentication screen when access to the digital signature verification service unit from the information processing apparatus is made using the IP address in a state in which the user authentication unit is valid.

In this way, in the second embodiment, when the authentication is successful in the user authentication unit, identification information of the information processing apparatus is registered in the passwordless login completion device list. When the access to the user authentication unit is made using the IP address and the identification information is included in the passwordless login completion device list, redirection to the URL on the pass key authentication screen is made.

In this configuration, a user who also makes access to the pass key authentication with the IP address after the second time can display a pass key authentication screen without performing an operation and perform pass key login.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing apparatus or the like through a network or various storage media. Then, a computer (or a CPU, an MPU, or the like) of the image processing apparatus or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-024274, filed on Feb. 21, 2024, which is hereby incorporated by reference herein in its entirety.

What is claimed is:

1. An image processing apparatus comprising at least one processor or circuit configured to function as:
a user authentication unit configured to perform user authentication by verifying a digital signature using a public key stored in advance in association with an identifier of a user, wherein the digital signature is received from an information processing apparatus through HTTP communication; and
a control unit configured to generate a cooperation authentication screen or a pass key authentication screen for prompting access by authentication using pass key corresponding to the public key when access to the user authentication unit from the information processing apparatus is made using an IP address in a state in which the user authentication unit is valid.

2. The image processing apparatus according to claim 1, wherein the at least one processor or circuit is further configured to function as a user authentication switching unit configured to switch a setting of validity/invalidity of the user authentication unit.

3. The image processing apparatus according to claim 1, wherein, on the cooperation authentication screen, a URL link to the pass key authentication screen is displayed.

4. The image processing apparatus according to claim 3, wherein, when the URL link is pressed, the pass key authentication screen is displayed.

5. The image processing apparatus according to claim 1, wherein a setting regarding whether to perform auto registration in a DNS is enabled in the state in which the user authentication unit is valid.

6. The image processing apparatus according to claim 5, wherein, when the auto registration in the DNS is set, a host name and an IP address are registered in the DNS.

7. The image processing apparatus according to claim 1,
wherein, when the user authentication unit performs the authentication successfully, identification information of the information processing apparatus is registered in a passwordless login completion device list, and
wherein, when access to the user authentication unit is made using an IP address and the identification information is included in the passwordless login completion device list, redirection to a URL on the pass key authentication screen is performed.

8. An image processing apparatus comprising at least one processor or circuit configured to function as:
a user authentication unit configured to perform user authentication by receiving a digital signature from an information processing apparatus through HTTP communication and verifying the digital signature using a public key stored in advance in association with an identifier of a user; and
a DNS registration setting unit configured to set whether to perform auto registration in a DNS in a state in which the user authentication unit is valid.

9. The image processing apparatus according to claim 8, wherein, when the DNS registration setting unit is set to perform auto registration in the DNS, a host name and an IP address are registered in the DNS.

10. A non-transitory computer-readable storage medium configured to store a computer program comprising instructions for executing following processes of:
performing user authentication by verifying a digital signature using a public key stored in advance in association with an identifier of a user, wherein the digital signature is received from an information processing apparatus through HTTP communication; and
setting whether to perform auto registration in a DNS in a state in which the user authentication unit is valid.

11. A system including an image processing apparatus and an information processing apparatus,
wherein the information processing apparatus comprises at least one processor or circuit configured to function as a sending unit configured to send a digital signature created by using a pass key to the image processing apparatus through HTTP communication;
wherein the image processing apparatus comprises at least one processor or circuit configured to function as:
a user authentication unit configured to perform user authentication by verifying the digital signature using a public key stored in advance in association with an identifier of a user; and
a control unit configured to generate a cooperation authentication screen or a pass key authentication screen for prompting access by authentication using the pass key corresponding to the public key when access to the user authentication unit from the information processing apparatus is made using an IP address in a state in which the user authentication unit is valid.

12. A system including an image processing apparatus and an information processing apparatus,
wherein the information processing apparatus comprises at least one processor or circuit configured to function as a sending unit configured to send a digital signature created by using a pass key to the image processing apparatus through HTTP communication;
wherein the image processing apparatus comprising at least one processor or circuit configured to function as:
a user authentication unit configured to perform user authentication by verifying the digital signature using a public key stored in advance in association with an identifier of a user; and
a DNS registration setting unit configured to set whether to perform auto registration in a DNS in a state in which the user authentication unit is valid.
